(19) United States
(12) Patent Application Publication
(10) Pub. No.: US 2009/0070360 A1
(43) Pub. Date: Mar. 12, 2009

(54) METHODS AND SYSTEMS INVOLVING SOCIAL BOOKMARKING

(75) Inventor: Ruthie D. Lyle, Durham, NC (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/852,554

(22) Filed: Sep. 10, 2007

(51) Int. Cl. G06F 7/00

(52) U.S. Cl. 707/102

(57) ABSTRACT

A method for compiling bookmarks comprising, receiving a session name, receiving a user identifier, the user identifier identifies a user selected to join a group associated with the session name, sending an invitation to join the group to the user, adding the user to the group responsive to receiving an acceptance of the invitation from the user, and starting a session responsive to receiving an the acceptance of the invitation, the session comprising, receiving an Internet Uniform Resource Locator (URL) from the user, receiving a title from the user, wherein the tile is descriptive of the URL, receiving a tag from the user, wherein the tag is a descriptive word associated with the URL, associating the URL, the title, and the tag with the session name and the user identifier, and storing the URL, the title, the tag, and the associated session name and the user identifier in a database.

### BACKGROUND OF THE INVENTION

1. Field of the Invention

This invention relates to bookmarking Internet data and particularly to collaboratively bookmarking Internet data.

2. Description of Background

Users may use an Internet browser to search the Internet and find information. Often users desire to use bookmarks to save the Internet URL addresses of web pages that contain information that the user may intend to revisit.

Prior social bookmarking systems allow a user to compile a database of bookmarks and associate tags with each bookmark. The database the user has compiled is available to other users who may use the tags to find bookmarks of interest in the database. Other users may also compile databases of bookmarks and share their database.

The social bookmarking systems limit the scope of the database to compilations of bookmarks complied by a single user for sharing. The social bookmarking systems do not allow a number of users to collaboratively compile and tag bookmarks that may be included in a single database. Additionally, the social bookmarking systems do not allow users to selectively make some bookmarks available to a particular user, or a particular group of users.

### SUMMARY OF THE INVENTION

The shortcomings of the prior art are overcome and additional advantages are provided through the provision of a method for compiling bookmarks comprising, receiving a session name, receiving a user identifier, wherein the user identifier identifies a user selected to be invited to join a group associated with the session name, sending an invitation to join the group to the user, adding the user to the group responsive to receiving an acceptance of the invitation from the user, and starting a session responsive to receiving an the acceptance of the invitation from the user, the session comprising, receiving an Internet Uniform Resource Locator (URL) from the user, receiving a title from the user, wherein the tile is descriptive of the URL, receiving a tag from the user, wherein the tag is a descriptive word associated with the URL, associating the URL, the title, and the tag with the session name and the user identifier, and storing the URL, the title, the tag, and the associated session name and the user identifier in a database.

An exemplary system for compiling bookmarks comprising, a database, and a processor, wherein the processor is operative to, receive a session name, receive a user identifier, wherein the user identifier identifies a user selected to be invited to join a group associated with the session name, send an invitation to join the group to the user, add the user to the group responsive to receiving an acceptance of the invitation from the user, receive an Internet Uniform Resource Locator (URL) from the user, receive a tag from the user, wherein the tag is a descriptive word associated with the URL, associate the URL and the tag with the session name and the user identifier, and store the URL, the tag, and the associated session name and the user identifier in the database.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic block diagram illustrating an exemplary embodiment of a social bookmarking system.

FIG. 2. is a schematic block diagram illustrating an exemplary embodiment of a method for social bookmarking.

FIG. 3 is a schematic diagram illustrating an exemplary embodiment of a graphical data entry display.

FIG. 4 is a schematic block diagram illustrating another exemplary embodiment of a graphical data entry display.

The detailed description explains the preferred embodiments of the invention, together with advantages and features, by way of example with reference to the drawings.

### DETAILED DESCRIPTION OF THE INVENTION

Systems and methods involving social bookmarking are provided herein.

In this regard, a social bookmarking system allows a user to compile a number of uniform resource locators (URL) from the Internet and save the URLs in a database that may be accessed by other users. The database may include the URL and data the user associates with the URL such as, tags and other descriptions of the URL. Tags are descriptive words associated with the URL that may be grouped into tag clouds. Once a user has associated tags with a URL, other users may use the tags to find the URL in the database.

The database may also include the name of the user who entered the URL into the database. Previous examples of social bookmarking systems only allow a user to compile a list of bookmarks that are associated with the user. It is desirable for a social bookmarking system to allow multiple users to collaboratively compile a database that includes bookmarking data that may be shared among database users. It is also desirable for the users to be associated in a group having a session name to classify the collaborative compilation of bookmarking data.

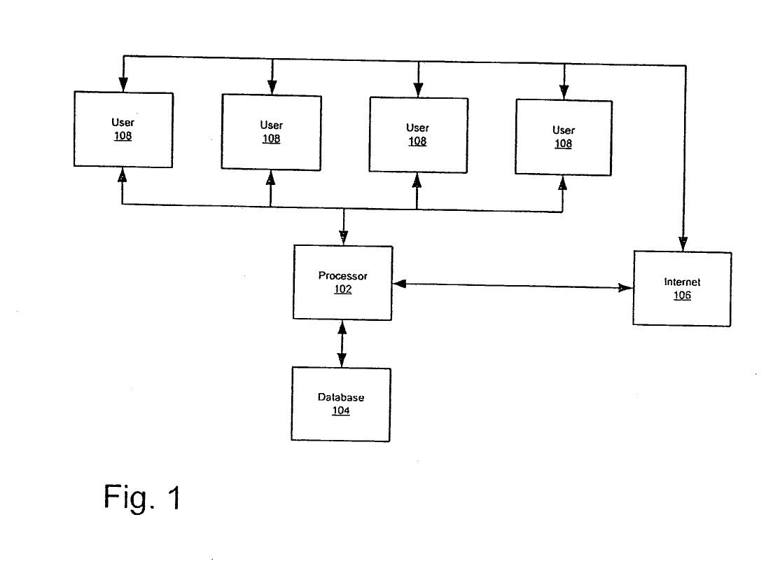

FIG. 1 illustrates an exemplary embodiment of a social bookmarking system. The social bookmarking system illustrated in FIG. 1 includes a processor 102 communicatively linked to a database 104, the Internet 106, and a plurality of user terminals 108. Each user terminal 108 may be communicatively linked to the Internet 106. In the exemplary embodiment, the Internet browsers include plug-ins that allow the users to initiate and participate in bookmarking sessions (sessions) administered by the processor 102. The processor 102 may be, for example located in a server.

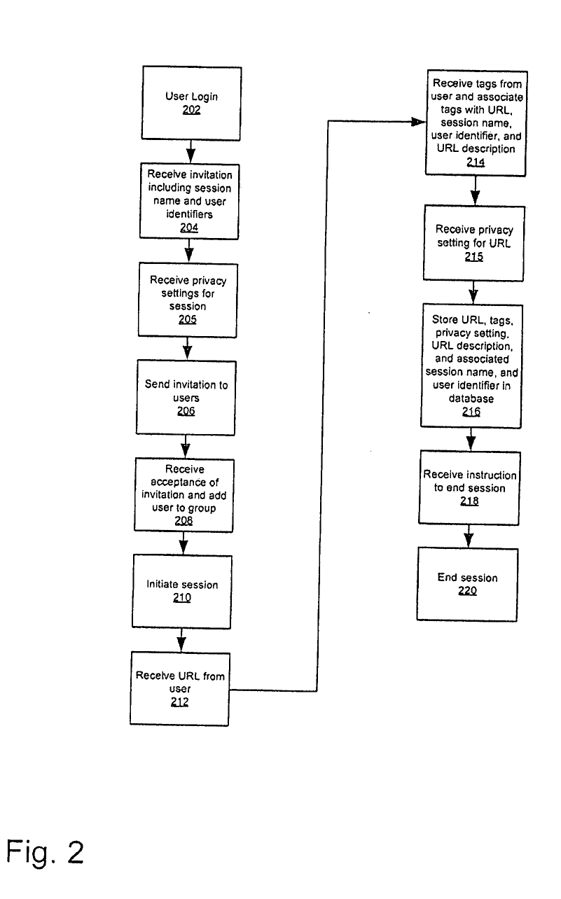

In operation, the processor 102 is operative to perform the method 200 illustrated in FIG. 2. Referring to FIG. 2, the illustrated method includes block 202 where users at user terminals 108 log on to Internet browsers that are enabled to communicate with the Internet 106 in block 202, the processor 102 (of FIG. 1), and the database 104 (of FIG. 1). A session initiator, who may be one of the users, directs the processor 102 to initiate a session by sending an invitation to other users of the system from a user terminal 108 to join a group associated with a session name defined by the initiator, the session name may include, for example, a topic of the social bookmarking search. In block 204, the processor 102 receives the session name entered by the initiator, the privacy setting for the session, and one or more user identifiers, for example screen names or email addresses.

In block 205, the processor may receive a privacy setting for the session. The processor sends the invitation to join the session to the users having the user identifiers in block 206. If a user accepts the invitation, the processor receives the acceptance of the invitation in block 208, and the processor adds the user to the group.

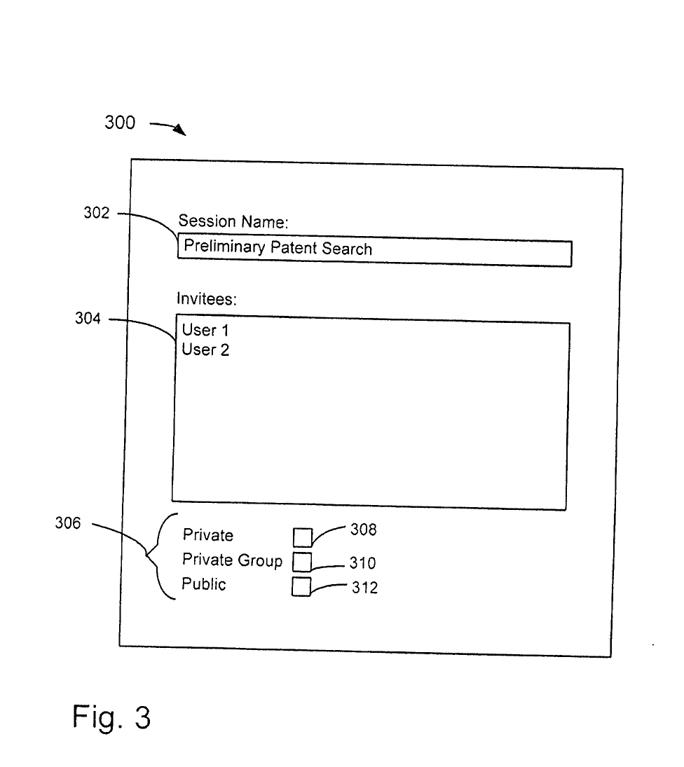

FIG. 3 illustrates an exemplary embodiment of a graphical input 300 the initiator uses to direct the processor 102 to initiate a session. In the exemplary embodiment of FIG. 3, an Internet browser on the user terminal 108 may for example, display the graphical input 300. The input 300 includes a session name input 302, and an invitee input 304 that includes a list of the user identifiers of the users invited to the session. In the illustrated embodiment, the initiator has entered a session name “Preliminary Patent Search” in the session name input 203 and has invited “User 1” and “User 2.” Once the initiator has entered the session name and the invited users, the invitee may direct the processor 102 to send the invitation to the invited users.

It may be desirable to limit the access users of the database or users in the group have to the URLs and the associated data compiled in the session. FIG. 3 includes privacy settings 306 that may be set for the entire session. The privacy settings 306 include a public setting 312 that allows all users of the database including users that are not members of the group associated with the session name access the URLs and the stored data associated with the URLs. Another included privacy setting is a private group setting 310 that allows only users that are members of the group associated with the session name to access the URLs and the data associated with the URLs that were added to the database 104 during the session. For example, if the session named “Preliminary Patent Search” of FIG. 3 was set to private group, only members of the group who participated in the session “Preliminary Patent Search” may access the URLs and the data associated with the URLs found during the session. The privacy settings also include a private setting 308 that only allows the user who entered each URL and the data associated with the each URL to access the entry.

Referring back to the method illustrated in FIG. 2, once the processor receives the acceptance of the invitation in block 208 and has added the user to the group, the processor 102 initiates the session in block 210. The processor 102 may continue to add additional users to the group as the processor 102 receives the accepted invitations.

The session includes the processor 102 receiving URL inputs from a user in the group in block 212. The processor 102 receives tags from the user that are descriptive words associated with the URL in block 214, and associates the URL and the tags with the session name and the user identifier for the user who entered the URL and the associated tags in block 214. The processor 102 may receive a URL description of the URL. The processor 102 may also receive privacy settings from the user for each URL sent to the processor 102 in block 215. In block 216, the processor 102 stores the URL, the tags, the privacy setting, the URL description and the associated session name and user identifier in the database 104 (of FIG. 1).

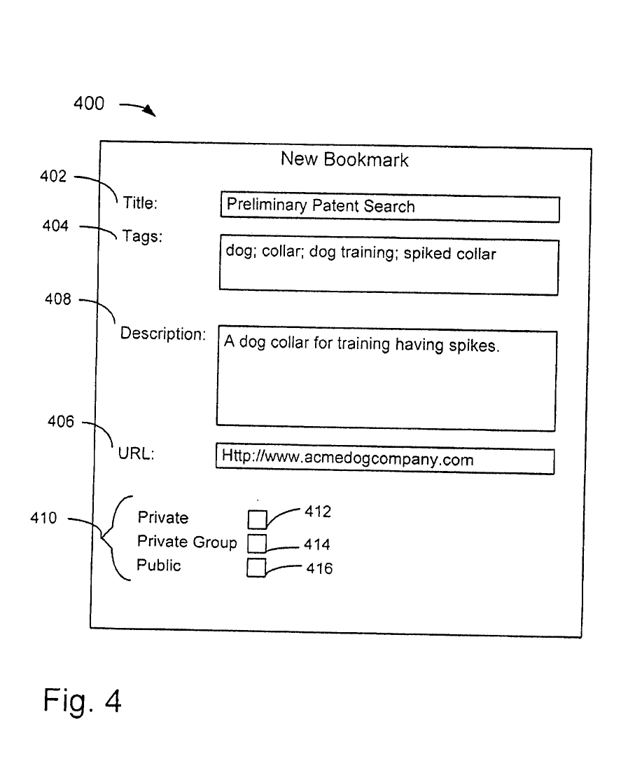

FIG. 4 illustrates an exemplary embodiment of a graphical input 400 a user in the group uses to send a URL and data associated with the URL to the processor 102. The input 400 includes a title input 402, a tag input 404, a URL input 406, a description input 408, and privacy settings 410. In the illustrated embodiment, the user has entered a title “Dog Training Collar” in the title input 402, and the URL “http://www.acmedogcompany.com” in the URL input 406. The user has entered the description “A dog collar for training having spikes.” in the description input 406. The user has entered the tags: “dog,” “collar,” “dog training,” and “spiked collar” in the tags input 404. The user may then send the URL and the associated data to the processor 104.

It may be desirable to limit the access users of the database or the users in the group have to particular URLs and the associated data compiled in the session. Block 215 (of FIG. 2) allows a user to set a privacy setting 410 for a particular URL and associated data entry. The input 400 includes a public setting 416 that allows all users of the database including users that are not members of the group associated with the session name access to the URL and the stored data associated with the URL. A private group setting 414 allows only users that are members of the group associated with the session name that the URL and the data associated with the URL were entered into the database 104 under to access the URL and the data associated with the URL. The privacy settings 410 also include a private setting 412 that only allows the user who entered the URL and the data associated with the URL to access the entry.

Referring back to the method illustrated in FIG. 2, the processor 102 ends the session upon receiving instructions from the initiator or the users in blocks 218 and 220. The instructions that initiate the ending of the session may include, for example, an instruction to end the session from the initiator or any member of the group, the expiration of a time duration defined by the initiator, and the initiator may define a percentage of users who have exited the session, thereby instructing the processor 102 to end the session responsive to the defined percentage of users exiting the session.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for compiling bookmarks, the method comprising:
receiving a session name;
receiving a user identifier, wherein the user identifier identifies a user selected to be invited to join a group associated with the session name;
sending an invitation to join the group to the user;
adding the user to the group, responsive to receiving an acceptance of the invitation from the user; and
starting a session responsive to receiving an the acceptance of the invitation from the user, the session comprising:
receiving an Internet Uniform Resource Locator (URL) from the user;
receiving a title from the user, wherein the tile is descriptive of the URL;
receiving a tag from the user, wherein the tag is a descriptive word associated with the URL;
associating the URL, the title, and the tag with the session name and the user identifier; and
storing the URL, the title, the tag, and the associated session name and the user identifier in a database.

2. The method of claim 1, further comprising:
receiving a description of the URL from the user;
associating the description of the URL with the URL; and
storing the associated description of the URL in the database.

3. The method of claim 1, further comprising:
receiving one of a plurality of privacy designations for the session name, wherein the plurality of privacy designations include:
a public designation operative to allow all database users access to the stored URL, tag, and user identifier associated with the session name;
a private group designation operative to allow only a user of the group associated with the session name access to the stored URL, tag, and user identifier associated with the session name; and
a private designation operative to allow only the user having the user identifier access the stored URL and tag associated with the user identifier.

4. The method of claim 1, further comprising:
receiving one of a plurality of privacy designations for the URL, wherein the plurality of privacy designations include:
a public designation operative to allow all database users access to the stored URL, tag, and user identifier associated with the URL;
a private group designation operative to allow only a user of the group associated with the session name access to the stored URL, tag, and user identifier associated with the session name; and
a private designation operative to allow only the user having the user identifier access the stored URL and tag associated with the user identifier.

5. The method of claim 1, further comprising:
receiving an instruction to end the session from the user; and
ending the session responsive to receiving the instruction.

6. The method of claim 1, further comprising:
receiving an instruction to end the session from an initiator of the session; and
ending the session responsive to receiving the instruction.

7. The method of claim 1, further comprising:
receiving an instruction to end the session at the end of a time duration defined by an initiator of the session; and
ending the session at the end of the defined time duration.

8. The method of claim 1, further comprising:
receiving an instruction from an initiator of the session to end the session when a percentage of the users, defined by the initiator, in the group exit the session; and
ending the session responsive to the defined percentage of the users in the group exit the session.

9. A system for compiling bookmarks, comprising:
a database; and
a processor, wherein the processor is operative to, receive a session name, receive a user identifier, wherein the user identifier identifies a user selected to be invited to join a group associated with the session name, send an invitation to join the group to the user, add the user to the group responsive to receiving an acceptance of the invitation from the user, receive an Internet Uniform Resource Locator (URL) from the user, receive a tag from the user, wherein the tag is a descriptive word associated with the URL, associate the URL and the tag with the session name and the user identifier, and store the URL, the tag, and the associated session name and the user identifier in the database.
